(19) United States
(12) Patent Application Publication
(10) Pub. No.: US 2022/0172115 A1
(43) Pub. Date: Jun. 2, 2022

(54) PARAMETER TUNING APPARATUS, PARAMETER TUNING METHOD, COMPUTER PROGRAM AND RECORDING MEDIUM

(71) Applicant: NEC Corporation, Minato-ku, Tokyo (JP)

(72) Inventor: Yoshihiro Okada, Tokyo (JP)

(73) Assignee: NEC Corporation, Minato-ku, Tokyo (JP)

(21) Appl. No.: 17/437,244

(22) PCT Filed: Mar. 9, 2020
(86) PCT No.: PCT/JP2020/010009

§ 371 Date: Sep. 8, 2021

(30) Foreign Application Priority Data
Mar. 19, 2019 (JP) 2019-051402

(51) Int. Cl. G06N 20/00

(52) U.S. Cl. CPC G06N 20/00

(57) ABSTRACT

A parameter tuning apparatus includes: a generating unit that generates a plurality of combination patterns by combining a plurality of value candidates, which are values that can be respectively taken by a plurality of hyperparameters for defining behavior of machine learning; and a sorting unit that sorts the plurality of combination patterns by performing the machine learning with a plurality of value candidates included in each of the plurality of combination patterns. The sorting unit associates accuracy of a model obtained as an execution result of the machine learning with a corresponding combination pattern, and extracts a combination pattern in which the accuracy of the model associated with each of the plurality of combination patterns is within an allowable range.

### TECHNICAL FIELD

The present invention relates to a parameter tuning apparatus, a parameter tuning method, a computer program and a recording medium.

### BACKGROUND ART

For this type of apparatus, for example, proposed is an apparatus that automatically generates an image processing program, wherein, for each parameter of a parameter variable program, the apparatus sets a selection probability of the parameter to be higher as processing realized when the parameter is set for the parameter variable program has higher effectiveness (see Patent Literature 1). Furthermore, for example, also proposed is an apparatus that estimates, by a function, a relationship between hyperparameters and learning results from the tendency of the learning results of learning processing and that limits a value range of the hyperparameters on the basis of this function, when the hyperparameters are tuned (see Patent Literature 2). Other related technologies/techniques include Patent Literatures 3 to 6.

### CITATION LIST

### Patent Literature

Patent Literature 1: International Publication No. 2015/194006

Patent Literature 2: JP 2018-159992A

Patent Literature 3: JP 2018-120373A

Patent Literature 4: JP 2018-092632A

Patent Literature 5: JP 2017-111548A

Patent Literature 6: JP 6109631B

### SUMMARY OF INVENTION

### Technical Problem

In data analysis, it is preferable to perform the tuning of hyperparameters in order to increase the accuracy of a learning model relating to machine learning. There are, for example, grid search, random search, Bayesian optimization, etc., known as techniques for tuning. In particular, the grid search has the merit that it is relatively easily performed without requiring advanced skill, because it is a technique to solve the problem by combining multiple parameter values. On the other hand, it is known that the grid search has increased computational complexity with increasing number of the parameter values to be combined. For this reason, it is hardly possible to calculate all the combination of multiple parameter values, for example, in situations where there are constraints on a machine resource and a time for generating learning model. Under this circumstance, the combination of parameter values to be calculated and the range of parameter values are often narrowed down and determined on the basis of experience and knowledge of a data scientist. However, there is a technical problem that there may be a relatively large difference in the accuracy of a learning model depending on the judgment result of the data scientist.

In view of the above-described problems, it is therefore an example object of the present invention to provide a parameter tuning apparatus, a parameter tuning method, a computer program, and a recording medium that are configured to efficiently perform grid search even when there are constraints on machine resources or time constraints.

### Solution to Problem

A parameter tuning apparatus according to an example aspect of the present invention includes: a generating unit that generates a plurality of combination patterns by combining a plurality of value candidates, which are values that can be respectively taken by a plurality of hyperparameters for defining behavior of machine learning; and a sorting unit that sorts the plurality of combination patterns by performing the machine learning with a plurality of value candidates included in each of the plurality of combination patterns, wherein the sorting unit associates accuracy of a model obtained as an execution result of the machine learning with a corresponding combination pattern, and extracts a combination pattern by which the accuracy of the model associated with each of the plurality of combination patterns is within an allowable range.

A parameter tuning method according to an example aspect of the present invention includes: a generating step in which a plurality of combination patterns are generated by combining a plurality of value candidates, which are values that can be respectively taken by a plurality of hyperparameters for defining behavior of machine learning; and a sorting step in which the plurality of combination patterns are sorted by performing the machine learning with a plurality of value candidates included in each of the plurality of combination patterns, wherein in the sorting step, accuracy of a model obtained as an execution result of the machine learning is associated with a corresponding combination pattern, and a combination pattern in which the accuracy of the model associated with each of the plurality of combination patterns is within an allowable range is extracted.

A computer program according to an example aspect of the present invention allows a computer to perform the parameter tuning method according to the example aspect described above.

A recording medium according to an example aspect of the present invention is a recording medium on which the computer program according to the example aspect described above is recorded.

### Advantageous Effects of Invention

According to the parameter tuning apparatus, the parameter tuning method, the computer program, and the recording medium in the respective example aspects described above, the grid search can be efficiently performed even when there are constraints on machine resources or time constraints.

### BRIEF DESCRIPTION OF DRAWINGS

FIG. 1 is a block diagram illustrating a hardware configuration of a parameter tuning apparatus according to an example embodiment.

FIG. 2 is a block diagram illustrating a functional block implemented in a CPU according to the example embodiment.

FIG. 3 is a flowchart illustrating the operation of the parameter tuning apparatus according to the example embodiment.

FIG. 4 are conceptual diagrams illustrating a concept of sorted combination patterns.

FIG. 5 is a block diagram illustrating a functional block implemented in a CPU according to a modified example of the example embodiment.

### DESCRIPTION OF EXAMPLE EMBODIMENTS

A parameter tuning apparatus, a parameter tuning method, a computer program, and a recording medium according to an example embodiment will be described with reference to the drawings. The following describes the parameter tuning apparatus, the parameter tuning method, the computer program, and the recording medium according to the example embodiment, by using a parameter tuning apparatus 1 that uses grid search to perform turning of hyperparameters for defining the behavior of machine learning.

(Configuration)

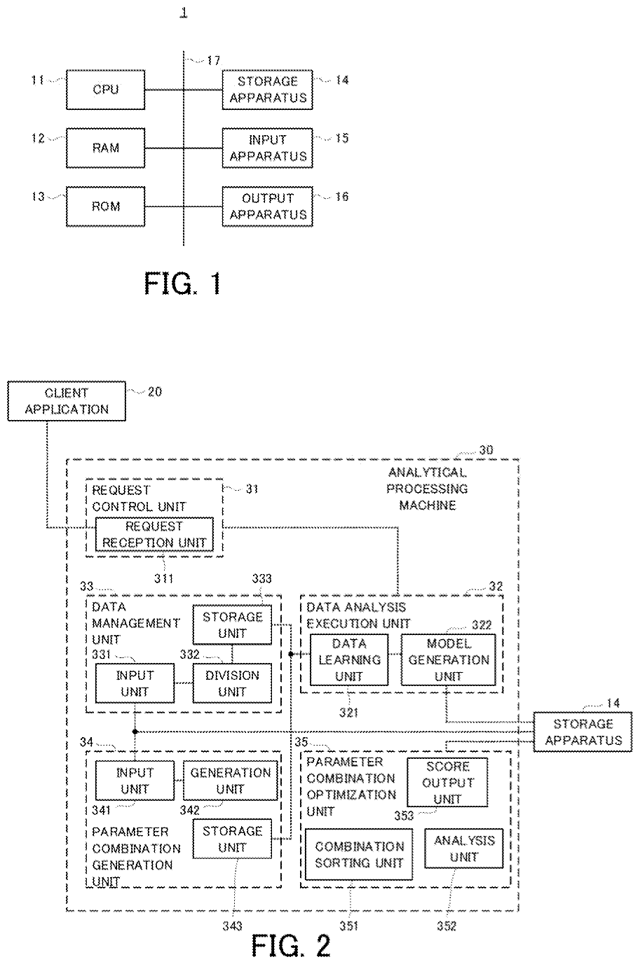

First, a hardware configuration of the parameter tuning apparatus 1 according to an example embodiment will be described with reference to FIG. 1. FIG. 1 is a block diagram illustrating the hardware configuration of the parameter tuning apparatus 1 according to the example embodiment.

In FIG. 1, the parameter tuning apparatus 1 includes a CPU (Central Processing Unit) 11, a RAM (Random Access Memory) 12, a ROM (Read Only Memory) 13, a storage apparatus 14, an input apparatus 15, and an output apparatus 16. The CPU 11, the RAM 12, the ROM 13, the storage apparatus 14, the input apparatus 15 and the output apparatus 16 are interconnected through a data bus 17.

The CPU 11 reads a computer program. For example, the CPU 11 may read a computer program stored by at least one of the RAM 12, the ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not illustrated apparatus disposed outside the parameter tuning apparatus 1, through a network interface. The CPU 11 controls the RAM 12, the storage apparatus 14, the input apparatus 15, and the output apparatus 16 by executing the read computer program. Especially in this example embodiment, when the CPU 11 executes the read computer program, a logical functional block for tuning hyperparameters is implemented in the CPU 11. In other words, the CPU 11 is configured to function as a controller for tuning hyperparameters. A configuration of the functional block implemented in the CPU 11 will be described in detail later with reference to FIG. 2.

The RAM 12 temporarily stores the computer program to be executed by the CPU 11. The RAM 12 temporarily stores the data that are temporarily used by the CPU 11 when the CPU 11 executes the computer program. The RAM 12 may be, for example, a D-RAM (Dynamic RAM).

The ROM 13 stores a computer program to be executed by the CPU 11. The ROM 13 may otherwise store fixed data. The ROM 13 may be, for example, a P-ROM (Programmable ROM).

The storage apparatus 14 stores the data that are stored for a long term by the parameter tuning apparatus 1. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the parameter tuning apparatus 1. The input apparatus 15 may include, for example, at least one of a keyboard, a mouse, and a touch panel.

The output apparatus 16 is an apparatus that outputs information about the parameter tuning apparatus 1, to the outside. For example, the output apparatus 16 may be a display apparatus that is configured to display the information about the parameter tuning apparatus 1.

Next, a configuration of the functional block implemented in the CPU 11 will be described with reference to FIG. 2. FIG. 2 is a block diagram illustrating the functional block implemented in the CPU 11.

As illustrated in FIG. 2, a client application 20 and an analytical processing machine 30 are implemented in the CPU 11 as the logical functional block for tuning hyperparameters.

The analytical processing machine 30 includes a request control unit 31, a data analysis execution unit 32, a data management unit 33, a parameter combination generation unit 34 and a parameter combination optimization unit 35. The request control unit 31 includes a request reception unit 311. The data analysis execution unit 32 includes a data learning unit 321 and a model generation unit 322. The data management unit 33 includes an input unit 331, a division unit 332, and a storage unit 333. The parameter combination generation unit 34 includes an input unit 341, a generation unit 342 and a storage unit 343. The parameter combination optimization unit 35 includes a combination sorting unit 351, an analysis unit 352 and a score output unit 353. The storage units 333 and 343 may be configured by a cache memory of the CPU 11.

The client application 20 provides the user of the parameter tuning apparatus 1 with information about the parameter tuning apparatus 1, via the output apparatus 16. In particular, the client application 20 presents, to the user, information for confirming the user's intention to perform the tuning of hyperparameters (e.g., a selectable button described as “execution start” and so on). When the input apparatus 15 receives an input indicating the user's execution intention, the client application 20 transmits an analysis request, which is a signal indicating the start of execution of tuning, to the request reception unit 311 of the request control unit 31 of the analytical processing machine 30.

The request control unit 31 controls the analysis request from the client application 20 (that is, the user of the parameter tuning apparatus 1). Specifically, when the request reception unit 311 receives the analysis request, the request control unit 31 transmits a signal indicating the start of analytical processing to the data analysis execution unit 32.

The data analysis execution unit 32 performs learning processing as the analytical processing on the basis of the analysis data that are managed by the data management unit 33 (which will be described in detail later) and the combination of hyperparameters that is generated by the parameter combination generation unit 34 (which will be described in detail later). Especially in the data analysis execution unit 32, the data learning unit 321 performs the learning processing (that is, machine learning) based on the analysis data and the combination of hyperparameters, and the model generation unit 322 generates a model used for predictive analysis from the result of the learning processing.

The data management unit 33 manages the analytical data that are used in the learning processing in the data analysis execution unit 32. In the data management unit 33, first, the input unit 331 reads a predetermined dataset, for example, from the storage apparatus 14. Then, the division unit 332 divides the dataset, thereby to generate a plurality of analysis data used for the learning processing in the data analysis execution unit 32. The plurality of analysis data are stored in the storage unit 333. Here, the division unit 332 divides the dataset on the basis of a definition information of the number of data divisions corresponding to the number of patterns of cross validation, because the cross validation (CV) is performed in the parameter tuning apparatus 1.

The parameter combination generation unit 34 generates combination patterns of the hyperparameters (i.e., patterns of the combination of respective parameter values of a plurality of hyperparameters). In the parameter combination generation unit 34, first, the input unit 341 reads a definition information of the hyperparameters (for example, information indicating candidates of possible values), for example, from the storage apparatus 14. Then, the generation unit 342 generates a list indicating a plurality of combination patterns of hyperparameters, on the basis of the definition information. The list is stored in the storage unit 343.

The parameter combination optimization unit 35 optimizes the combination of hyperparameters. Here, in the data analysis execution unit 32, the model generated from the result of the learning processing performed by using the analysis data (i.e., learning data) (that is, the model generated by the model generation unit 322) and an accuracy result that is the evaluation of the generated model using validation data (which is generated at the same time as the analysis data when the dataset is divided by the division unit 332 of the data management unit 33) are associated with each other, and are stored, for example, in the storage apparatus 14. The parameter combination optimization unit 35 optimizes the combination of the hyperparameters on the basis of the accuracy result associated with the model, or the like.

In the parameter combination optimization unit 35, first, the combination sorting unit 351 validates the effectiveness of the combination patterns. Specifically, the combination sorting unit 351 excludes, from the list, a combination pattern that results in an execution error in the learning processing in the data analysis execution unit 32 among the plurality of combination patterns indicated by the list. Then, the analysis unit 352 extracts a combination pattern whose accuracy is within an allowable range (in other words, a combination pattern whose accuracy is out of the allowable range is excluded) on the basis of the accuracy result associated with the model and the combination pattern corresponding to the model (that is, the combination pattern used for the learning processing when the model is generated). The “allowable range” may be preset, for example, by the user of the parameter tuning apparatus 1, or may be automatically set by the parameter tuning apparatus 1. At this time, the “allowable range” may be set by an absolute value of accuracy, or may be set as a relative range (e.g., xx % from a high precision side).

The combination pattern extracted by the analysis unit 352 (i.e., the combination pattern that is not excluded from the list) and the accuracy result associated with the corresponding model are related to each other, and are temporarily stored, for example, in the storage apparatus 14. When the parameter value that causes deterioration of the accuracy is specified on the basis of the plurality of parameter values included in the extracted combination pattern and the related accuracy result, the analysis unit 352 further excludes a combination pattern including the specified parameter value from the list. The score output unit 353 outputs a score indicating a relationship between the combination pattern that is not excluded from the list and the accuracy result associated with the corresponding model. The outputted score is presented to the user of the parameter tuning apparatus 1 via the output apparatus 16.

(Operation)

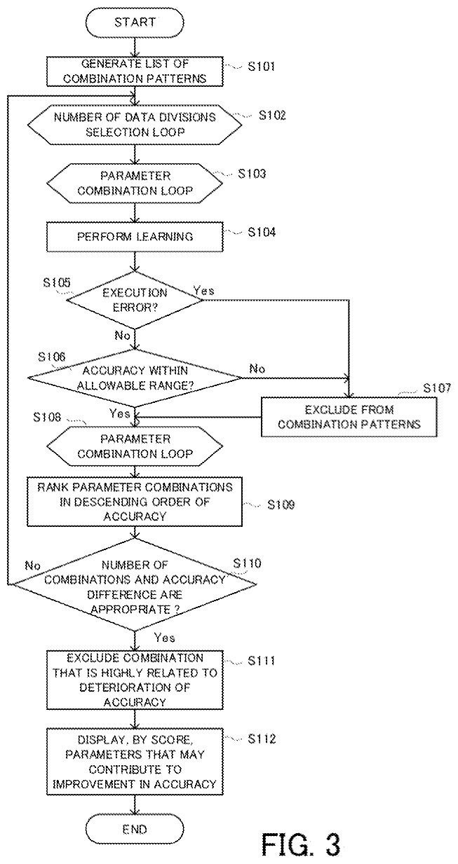

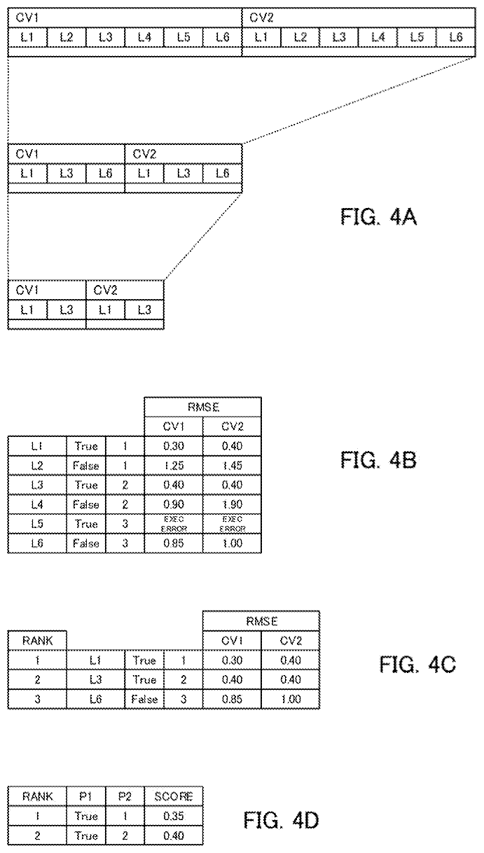

Next, the operation of the parameter tuning apparatus 1 will be described with specific examples with reference to FIG. 3 and FIG. 4 in addition to FIG. 2. FIG. 3 is a flowchart illustrating the operation of the parameter tuning apparatus according to the example embodiment. FIG. 4 are conceptual diagrams illustrating a concept of sorting the combination patterns.

In FIG. 3, first, the generation unit 342 of the parameter combination generation unit 34 generates the list indicating the plurality of combination patterns (a step S101). Here, it is assumed that there are P1 and P2 as the hyperparameters, that the possible values of P1 is “True” and “False”, and that the possible values of P2 is “1”, “2” and “3”. In this case, the combination patterns are L1 {True, 1}, L2 {False, 1}, L3 {True, 2}, L4 {False, 2}, L5 {True, 3} and L6 {False, 3}. Incidentally, “L1” to “L6” are identifiers of the combination patterns.

Then, the division unit 332 of the data management unit 33 divides the dataset read by the input unit 331 and generates a plurality of analysis data (a step S102). Here, an initial value of the number of divisions is “2”, and the number of divisions is increased by “1” when the step S102 is performed again after branching to “No” in a step S110 that will be described later. It is assumed that “CV1” and “CV2” are generated as the analysis data by the division unit 332.

Then, the data learning unit 321 of the data analysis execution unit 32 performs the learning processing by using one combination pattern selected from the combination patterns generated in the process of the step S101 and one analysis datum selected from the analysis data generated in the process of the step S102 (a step S103, a step S104).

Specifically, for example, the data learning unit 321 repeats the step S103 and the step S104 until the learning processing using L1 {True, 1} and CV1, the learning processing using L2 {False, 1} and CV1, the learning processing using L3 {True, 2} and CV1, the learning processing using L4 {False, 2} and CV2, the learning processing using L5 {True, 3} and CV2, and the learning processing using L6 {False, 3} and CV2 are completed. In this situation, the learning processing is performed twelve times in total, as illustrated on the top of FIG. 4A.

FIG. 4B illustrates an example of the accuracy result of each model generated by the model generation unit 322 from the result of the learning processing in the data analysis execution unit 32. In FIG. 4B, the accuracy result is expressed as a RMSE (Root Mean Square Error). When the dataset is divided into two parts, i.e., into CV1 and CV2, the accuracy of the model generated by the learning processing that uses CV1 as the analysis data is generated by an evaluation that uses CV2 as the validation data, and the accuracy of the model generated by the learning processing that uses CV2 as the analysis data is generated by an evaluation that uses CV1 as the validation data.

In FIG. 4B, the model generated from the result of the learning processing using L1 {True, 1} and CV1 has a RMSE of 0.30, and the model generated from the result of the learning processing using L1 {True, 1} and CV2 has a RMSE of 0.40. The model generated from the result of the learning processing using L2 {False, 1} and CV1 has a RMSE of 1.25, and the model generated from the result of the learning processing using L2 {False, 1} and CV2 has a RMSE of 1.45. The model generated from the result of the learning processing using L3 {True, 2} and CV1 has a RMSE of 0.40, and the model generated from the result of the learning processing using L3 {True, 2} and CV2 has a RMSE of 0.40. The model generated from the result of the learning processing using L4{False, 2} and CV1 has a RMSE of 0.90, and the model generated from the result of the learning processing using L4 {False, 2} and CV2 has a RMSE of 1.90. The learning processing using L5 {True, 3} and CV1 or CV2 results in an execution error (i.e., the learning processing did not complete successfully). The model generated from the result of the learning processing using L6{False, 3} and CV1 has a RMSE of 0.85, and the model generated from the result of the learning processing using L6 {False, 3} and CV2 has a RMSE of 1.00.

Then, the combination sorting unit 351 of the parameter combination optimization unit 35 determines whether or not an execution error has occurred in the learning processing for one combination pattern (a step S105). In the process of the step S105, when it is determined that an execution error has occurred (the step S105: Yes), the combination sorting unit 351 excludes the one combination pattern (step S107).

In the process of the step S105, when it is determined that no execution error has occurred (the step S105: No), the analysis unit 352 determines whether or not the accuracy result (for example, the RMSE in FIG. 4B) associated with the model corresponding to the one combination pattern is within the allowable range (a step S106). In the process of the step S106, when it is determined that the accuracy result is out of the allowable range (the step S106: No), the analysis unit 352 excludes the one combination pattern (the step S107). On the other hand, in the process of the step S106, when it is determined that the accuracy is within the allowable range (the step S106: Yes), the parameter combination optimization unit 35 performs the step S105 and subsequent steps for the other combination patterns. The step S105 to the step S107 are performed for all of the plurality of combination patterns on which the learning processing is performed (step S108).

Referring again to FIG. 4B, in the process of the step S105 to the step S107 described above, first, L5 {True, 3} that results in an execution error is excluded. The RMSE indicates that the accuracy deteriorates as the value increases. For example, when the allowable range is set to be greater than or equal to 0 and less than or equal to 1.00, L2 {False, 1} and L4 {False, 2} in which the RMSE exceeds 1.00 are excluded. Consequently, the parameter combination optimization unit 35 extracts L1 {True, 1}, L3 {True, 2} and L6{False, 3} (see the middle part of FIG. 4A). The extracted L1 {True, 1}, L3 {True, 2} and L6{False, 3} are an example of the “first sorted combination pattern” in Supplementary Note that will be described later.

After the process of the step S108, the parameter combination optimization unit 35 ranks relationships between the not-excluded (in other words, extracted) combination patterns and the accuracy results associated with the corresponding models in the descending order of the accuracy and stores them, for example, in the storage apparatus 14 (a step S109). In the example illustrated in FIG. 4, the ranking is as illustrated in FIG. 4C.

Then, the parameter combination optimization unit 35 determines whether or not the number of the not-excluded combination patterns and an accuracy difference between the combination patterns that are not excluded are appropriate (a step S110). For example, the parameter combination optimization unit 35 may determine that the number of the not-excluded combination patterns is not appropriate when the number of the not-excluded combination patterns is less than a predetermined number (e.g., a predetermined number that allows a determination of whether or not the number of the not-excluded combination patterns is too small). For example, the parameter combination optimization unit 35 may determine that the accuracy difference between the not-excluded combination patterns is not appropriate when the accuracy difference between the not-excluded combination patterns is less than a predetermined amount. In the process of the step S110, when it is determined that they are not appropriate (the step S110: No), the step S102 and the subsequent steps described above are performed again.

In the process of the step S110, when it is determined that they are appropriate (the step S110: Yes), then, when a parameter value that causes the deterioration of the accuracy is specified on the basis of a plurality of parameter values included in the not-excluded (in other words, extracted) combination patterns and the accuracy results associated with the corresponding models, the analysis unit 352 of the parameter combination optimization unit 35 further excludes the combination pattern including the specified parameter value (a step S111).

In the example illustrated in FIG. 4, the RMSE as the accuracy result of L6{False, 3}, which is a combination pattern including “False”, is inferior to the other combination patterns, L1 {True, 1} and L3 {True, 2}. For this reason, the analysis unit 352 specifies “False” as the parameter value that causes the deterioration of the accuracy. Consequently, L6{False, 3} is excluded. In other words, L1 {True, 1} and L3 {True, 2} are extracted (see the lower part of FIG. 4A). The extracted L1 {True, 1} and L3 {True, 2} are an example of the second sorted combination pattern in Supplementary Note that will be described later.

Then, the score output unit 353 outputs a score indicating the relationship between the not-excluded combination pattern and the accuracy result associated with the corresponding model. The outputted score is presented to the user of the parameter tuning apparatus 1 via the output apparatus 16 (a step S112). At this time, for example, an image as illustrated in FIG. 4D is presented to the user.

By performing a series of steps described with reference to the flow chart of FIG. 3, for example, as illustrated in FIG. 4A, it is possible to efficiently narrow down the combination patterns of parameters. Note that the narrowed-down combination patterns may be used when the next analysis is performed (for example, when the learning processing is performed by using the analysis data that differ from the analysis data used for the current learning processing). At this time, the combination patterns are used for the analysis (e.g., tuning of the hyperparameters by the grid search) in descending order from the high ranking (i.e., high rank).

(Technical Effects)

The series of steps described above is a process that is intended to narrow down the combinations of the parameter values and the range of the parameter values, for tuning the hyperparameters (here, tuning by the grid search). In other words, in the parameter tuning apparatus 1, the narrowing down of the combinations of the parameter values and the range of parameter values, which is conventionally performed by experience and knowledge of the data scientist, is performed on the basis of the result of the learning processing in the data analysis execution unit 32. Therefore, according to the parameter tuning apparatus 1, it is possible to narrow down the combinations of parameter values and the range of parameter values without depending on a particular data scientist.

Since the above-described series of steps is intended to narrow down the combinations of parameter values and the range of parameter values, the initial value of the number of divisions of the dataset by the division unit 332 of the data management unit 33 is set to “2”, which is the minimum number of divisions that allows the cross validation. Therefore, it is possible to reduce the time for the series of steps described above (for example, when the initial value of the number of divisions is “3”, it takes one and a half times as long as the time required when the initial value is “2”). Consequently, it is possible to reduce the time required to narrow down the combinations of parameter values and the range of parameter values.

When the tuning of hyperparameters is performed in order to improve the generalization capability and the accuracy of the model after the combinations of parameter values and the range of parameter values are sufficiently narrowed down by the series of steps described above, then, the tuning can be performed more efficiently by the grid search even when there are constraints on machine resources or time-related constraints.

### Modified Examples

(1) The parameter tuning apparatus 1 described above may be set as a master machine, and a plurality of slave machines, each of which is a subordinate of the master machine, may be set to have the same configuration as that of the parameter tuning apparatus 1 described above, and the master machine and the plurality of slave machines may build a distributed configuration.

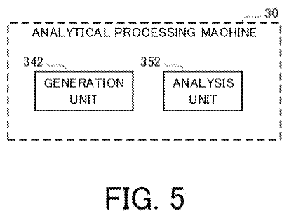

(2) As illustrated in FIG. 5, while the generation unit 342 of the parameter combination generation unit 34 and the analysis unit 352 of the parameter combination optimization unit 35 are implemented in the CPU 11 of the parameter tuning apparatus 1, a functional block other than the generation unit 342 and the analysis unit 352 may not be implemented. The functional block other than the generation unit 342 and the analysis unit 352 may be implemented in a different apparatus from the parameter tuning apparatus 1. Even in this instance, when the generation unit 342 performs the step S101 of FIG. 2 (i.e., the process of generating the plurality of combination patterns of the hyperparameters) and the analysis unit 352 performs the step S106 to the step S107 of FIG. 2 (i.e., the process of extracting the combination pattern in which the accuracy of the model is within the allowable range (wherein the analysis unit 352 may obtain information on the accuracy of the model in some way)), then, the combinations of parameter values and the range of parameter values are narrowed down correspondingly. As a result, the tuning can be performed more efficiently by the grid search even when there are constraints on machine resources or time constraints.

<Supplementary Note>

With respect to the example embodiments described above, the following Supplementary Notes will be further disclosed.

(Supplementary Note 1)

The parameter tuning apparatus described in Supplementary Note 1 is a parameter tuning apparatus including: a generating unit that generates a plurality of combination patterns by combining a plurality of value candidates, which are values that can be respectively taken by a plurality of hyperparameters for defining behavior of machine learning; and a sorting unit that sorts the plurality of combination patterns by performing the machine learning with a plurality of value candidates included in each of the plurality of combination patterns, wherein the sorting unit associates accuracy of a model obtained as an execution result of the machine learning with a corresponding combination pattern, and extracts a combination pattern by which the accuracy of the model associated with each of the plurality of combination patterns is within an allowable range.

(Supplementary Note 2)

The parameter tuning apparatus according to Supplementary Note 2 is the parameter tuning apparatus according to Supplementary Note 1, wherein, the sorting unit specifies a value candidate that is estimated to cause deterioration of the accuracy of the model on the basis of a plurality of value candidates included in each of a plurality of first sorted combination patterns that correspond to the extracted combination patterns from among the plurality of combination patterns and the accuracy of the model associated with each of the plurality of first sorted combination patterns, and extracts a first sorted combination pattern that does not include the specified value candidate.

(Supplementary Note 3)

The parameter tuning apparatus described in Supplementary Note 3 is the parameter tuning apparatus according to Supplementary Note 2, wherein, on the basis of the accuracy of the model associated with each of a plurality of second sorted combination patterns that correspond to the extracted first sorted combination patterns from among the plurality of first sorted combination patterns, the sorting unit outputs a score of each of the plurality of second sorted combination patterns.

(Supplementary Note 4)

The parameter tuning apparatus according to Supplementary Note 4 is the parameter tuning apparatus according to any one of Supplementary Notes 1 to 3, wherein, the sorting unit increases a number of divisions of input data used in the machine learning and performs the machine learning again by using the plurality of value candidates included in each of the plurality of combination patterns on condition that the extracted combination pattern does not satisfy a predetermined condition.

(Supplementary Note 5)

The parameter tuning method described in Supplementary Note 5 is a parameter tuning method including: a generating step in which a plurality of combination patterns are generated by combining a plurality of value candidates, which are values that can be respectively taken by a plurality of hyperparameters for defining behavior of machine learning; and a sorting step in which the plurality of combination patterns are sorted by performing the machine learning with a plurality of value candidates included in each of the plurality of combination patterns, wherein in the sorting step, accuracy of a model obtained as an execution result of the machine learning is associated with a corresponding combination pattern, and a combination pattern in which the accuracy of the model associated with each of the plurality of combination patterns is within an allowable range is extracted.

(Supplementary Note 6)

The computer program described in Supplementary Note 6 is a computer program that allows a computer to execute the parameter tuning method described in Supplementary Note 5.

(Supplementary Note 7)

The recording medium described in Supplementary Note 7 is a recording medium on which the computer program described in Supplementary Note 6 is recorded.

The present invention is allowed to be changed, if desired, without departing from the essence or spirit of the invention which can be read from the claims and the entire specification. A parameter tuning apparatus, a parameter tuning method, a computer program and a recording medium, which involve such changes, are also intended to be within the technical scope of the present invention.

This application is based upon and claims the benefit of priority from Japanese Patent Application No. 2019-051402, filed on Mar. 19, 2019, the disclosure of which is incorporated herein in its entirety by reference.

### DESCRIPTION OF REFERENCE CODES

1 . . . Parameter tuning apparatus, 11 . . . CPU, 12 . . . RAM, 13 . . . ROM, 14 . . . storage apparatus, 15 . . . input apparatus, 16 . . . output apparatus, 20 . . . client application, 30 . . . analytical processing machine, 31 . . . request control unit, 32 . . . data analysis execution unit, 33 . . . data management unit, 34 . . . parameter combination generation unit, 35 . . . parameter combination optimization unit

What is claimed is:

1. A parameter tuning apparatus comprising a controller,
the controller being programmed to:
generate a plurality of combination patterns by combining a plurality of value candidates, which are values that can be respectively taken by a plurality of hyperparameters for defining behavior of machine learning; and
sort the plurality of combination patterns by performing the machine learning with a plurality of value candidates included in each of the plurality of combination patterns, wherein
the controller is programmed to associate accuracy of a model obtained as an execution result of the machine learning with a corresponding combination pattern, and extracts a combination pattern by which the accuracy of the model associated with each of the plurality of combination patterns is within an allowable range.

2. The parameter tuning apparatus according to claim 1, wherein,
the controller is programmed to specify a value candidate that is estimated to cause deterioration of the accuracy of the model on the basis of a plurality of value candidates included in each of a plurality of first sorted combination patterns that correspond to the extracted combination patterns from among the plurality of combination patterns and the accuracy of the model associated with each of the plurality of first sorted combination patterns, and extracts a first sorted combination pattern that does not include the specified value candidate.

3. The parameter tuning apparatus according to claim 2, wherein,
on the basis of the accuracy of the model associated with each of a plurality of second sorted combination patterns that correspond to the extracted first sorted combination patterns from among the plurality of first sorted combination patterns, the controller is programmed to output a score of each of the plurality of second sorted combination patterns.

4. The parameter tuning apparatus according to claim 1 wherein,
the controller is programmed to increase a number of divisions of input data used in the machine learning and performs the machine learning again by using the plurality of value candidates included in each of the plurality of combination patterns on condition that the extracted combination pattern does not satisfy a predetermined condition.

5. A parameter tuning method comprising:
generating a plurality of combination patterns by combining a plurality of value candidates, which are values that can be respectively taken by a plurality of hyperparameters for defining behavior of machine learning; and
sorting the plurality of combination patterns by performing the machine learning with a plurality of value candidates included in each of the plurality of combination patterns, wherein
the generating includes associating accuracy of a model obtained as an execution result of the machine learning with a corresponding combination pattern, and extracting a combination pattern in which the accuracy of the model associated with each of the plurality of combination patterns is within an allowable range.

6. (canceled)

7. A non-transitory recording medium on which a computer program is recorded, wherein
the computer program allows a computer to execute a parameter tuning method,
the parameter tuning method includes:
generating a plurality of combination patterns by combining a plurality of value candidates, which are values that can be respectively taken by a plurality of hyperparameters for defining behavior of machine learning; and
sorting the plurality of combination patterns by performing the machine learning with a plurality of value candidates included in each of the plurality of combination patterns, wherein
the generating includes associating accuracy of a model obtained as an execution result of the machine learning with a corresponding combination pattern, and extracting a combination pattern in which the accuracy of the model associated with each of the plurality of combination patterns is within an allowable range.
